(19) United States
(12) Patent Application Publication
(10) Pub. No.: US 2026/0064788 A1
(43) Pub. Date: Mar. 5, 2026

(54) INFORMATION PROCESSING SYSTEM, INFORMATION PROCESSING METHOD, AND INFORMATION STORAGE MEDIUM

(71) Applicant: Rakuten Group, Inc., Tokyo (JP)

(72) Inventor: Carlos Antonio Kobashikawa Carrasco, Tokyo (JP)

(21) Appl. No.: 19/310,930

(22) Filed: Aug. 27, 2025

(30) Foreign Application Priority Data
Aug. 30, 2024 (JP) 2024-148553

(51) Int. Cl. G06F 16/9535; G06F 16/9538; G06Q 30/0251

(52) U.S. Cl. CPC G06F 16/9535; G06F 16/9538; G06Q 30/0256

(57) ABSTRACT

An information processing system acquires a first query; extracts at least one item from a plurality of items stored in advance, based on the first query; acquires another item associated with the at least one item being extracted; acquires at least one query associated with the other item as a second query; and outputs information according to the second query together with an item retrieved based on the first query.

### CROSS-REFERENCE TO RELATED APPLICATION

The present application claims priority from Japanese application JP2024-148553 filed on Aug. 30, 2024, the content of which is hereby incorporated by reference into this application.

### BACKGROUND

### 1. Field of the Disclosure

The present invention relates to an information processing system, an information processing method, and a program.

### 2. Description of the Related Art

Search result pages of E-commerce sites display advertisements corresponding to search queries inputted by users and items corresponding to the search queries.
[Patent Literature 1] JP2010-165171A

### SUMMARY

In order to propose more various items, it is conceivable to display an item corresponding to a search query and other items related to the item. Meanwhile, data indicating the relationship between items is required in advance so as to find other items related to a certain item, but the data is not always sufficient. Accordingly, for example, it is difficult to find new items as other items and the variety of the found other items is reduced, and thus a result useful for a user is not always obtained.

An object of the present disclosure is to provide a technique which enables a search for items that are desirable for a user, for example, items with variety and relation or new items, in an item search.

To solve the above-described problem, an information processing system according to the present disclosure includes: a first acquisition means which acquires a first query; an item extraction means which extracts at least one item from a plurality of items stored in advance, based on the first query; a relation acquisition means which acquires another item associated with the at least one item being extracted; a second acquisition means which acquires at least one query associated with the other item as a second query; and an output means which outputs information corresponding to the second query together with an item retrieved based on the first query.

An information processing method according to the present disclosure includes: acquiring a first query; extracting at least one item from a plurality of items stored in advance, based on the first query; acquiring another item associated with the at least one item being extracted; acquiring at least one query associated with the other item as a second query; and outputting information corresponding to the second query together with an item retrieved based on the first query.

A program according to the present disclosure causes a computer to function as: a first acquisition means which acquires a first query; an item extraction means which extracts at least one item from a plurality of items stored in advance, based on the first query; a relation acquisition means which acquires another item associated with the at least one item being extracted; a second acquisition means which acquires at least one query associated with the other item as a second query; and an output means which outputs information corresponding to the second query together with an item retrieved based on the first query.

According to the present invention, it is possible to search for an item more desirable for a user than searching only by a simple query.

### BRIEF DESCRIPTION OF THE DRAWINGS

FIG. 1 is a diagram for illustrating an example of elements related to a search system according to an embodiment of the present invention.

FIG. 2 is a block diagram for illustrating functions implemented in the search system.

FIG. 3 is a flowchart schematically for illustrating an example of processing of the search system.

FIG. 4 is a diagram for illustrating an example of a screen on which a query is inputted.

FIG. 5 is a diagram for illustrating an example of a screen displayed based on an output of a display control unit.

FIG. 6 is a diagram for illustrating an example of processing of an additional query acquisition unit.

FIG. 7 is a diagram for illustrating an example of data stored in a search history.

FIG. 8 is a diagram for illustrating an example of data stored in an action history.

FIG. 9 is a diagram for illustrating another example of processing of the additional query acquisition unit.

### DETAILED DESCRIPTION

Hereinafter, an embodiment of the present invention will be described with reference to the accompanying drawings. Repeated description will be omitted for components given the same reference numerals.

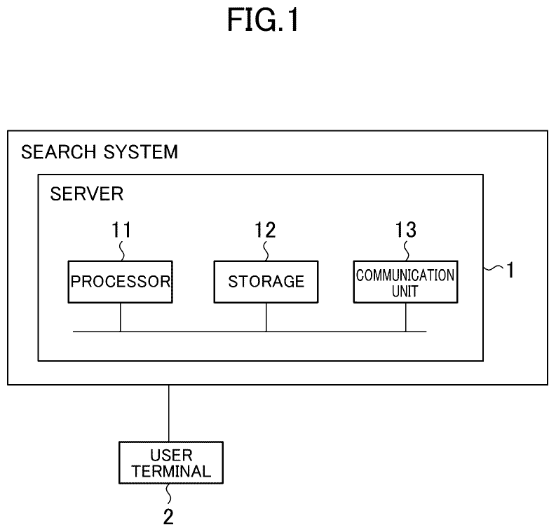

FIG. 1 is a diagram for illustrating an example of elements related to a search system according to the embodiment of the present invention. The search system includes one or more servers 1, and transmits/receives information to/from a user terminal 2 via a network (not shown). The search system acquires a query inputted by the user via the user terminal 2, and transmits information including an item selected based on the query to the user terminal 2. The user terminal 2 is a computer such as a personal computer and a smartphone.

The search system includes one or more servers 1. The server 1 includes one or more processors 11, one or more storages 12, and one or more communication units 13. The search system may include a plurality of computers each including one or more processors 11, storages 12, and communication units 13, or may include one computer including one or more processors 11 and storages 12. The search system may be implemented on one or more virtual servers or container platforms.

The processor 11 operates in accordance with a program (also referred to as instruction code) stored in the storage 12. The processor 11 controls the communication unit 13. The processor 11 includes, for example, a central processing unit (CPU), and may further include a graphic processing unit (GPU) or a neural processing unit (NPU). The program may be provided via the Internet or the like, or may be provided by being stored in a computer-readable storage medium such as a flash memory and a DVD-ROM.

The storage 12 is composed of a memory element such as a RAM and a flash memory, and an external storage device such as a hard disk drive (HDD) and a solid state drive (SSD). The storage 12 stores the above-mentioned program. The storage 12 stores information and calculation results inputted from the processor 11 and the communication unit 13.

The communication unit 13 is a communication interface that communicates with other devices, such as a network interface card. The communication unit 13 is composed of an integrated circuit, an antenna, a communication terminal, and the like for a wireless LAN or a wired LAN, for example. The communication unit 13 inputs information received from another device into the processor 11 or the storage 12 and transmits information to another device, via a network based on the control of the processor 11.

The hardware configuration of the search system is not limited to the above-mentioned example. For example, the search system may include a device (for example, a USB port) that inputs/outputs data to/from a device (for example, an optical disk drive or a memory card slot) that reads a computer-readable information storage medium or an external device. The external device may be an input device or an output device.

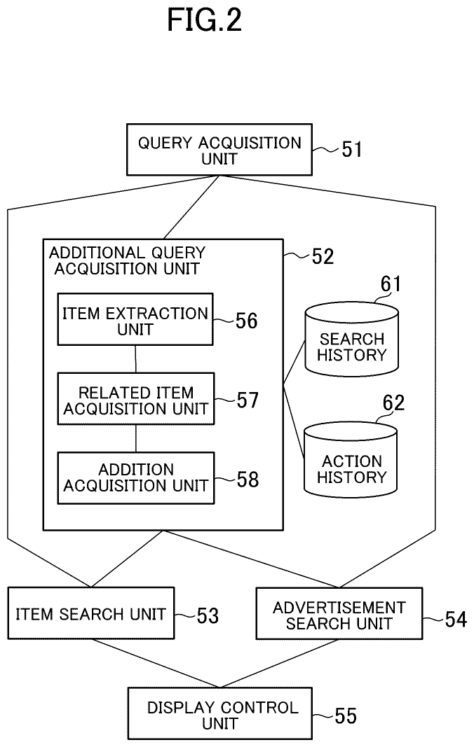

Next, functions provided by the search system will be described. FIG. 2 is a block diagram showing functions implemented in the search system. The search system functionally includes a query acquisition unit 51, an additional query acquisition unit 52, an item search unit 53, an advertisement search unit 54, a display control unit 55, a search history 61, and an action history 62. The additional query acquisition unit 52 functionally includes an item extraction unit 56, a related item acquisition unit 57, and an addition acquisition unit 58. The query acquisition unit 51, the additional query acquisition unit 52, the item search unit 53, the advertisement search unit 54, and the display control unit 55 are implemented by the processor 11 executing a program, which is stored in the storage 12 and corresponds to each function, and controlling the communication unit 13 and the like. The search history 61 and the action history 62 are stored in the storage 12.

The search history 61 stores at least one item in association with each of a plurality of queries inputted in the past by a plurality of users, the at least one item are selected from an item database based on corresponding one of the plurality of queries and subjected to a predetermined action (for example, purchase or browsing). Strictly speaking, an item stored here is identification information of the item. In the following description, an item other than items stored in the item database strictly refers to identification information of the item. The search history 61 stores information of not only a user who inputs a query but also many users. When information on many users is used for processing of the additional query acquisition unit 52 described later, the accuracy of the processing is improved and it becomes easy to secure variations of items to be displayed.

The search history 61 may be generated based on an input history of a search query and a browsing or purchase history of an item in the same session. In addition, the search history 61 may store queries inputted in the past by a plurality of users and items each having a matching degree to the query calculated by a known algorithm equal to or greater than a threshold value, among items extracted from the item database based on the queries, in association with a corresponding query.

In the action history 62, a plurality of items subjected to a predetermined action together are stored in a mutually associated manner. More specifically, in the action history 62, a plurality of items subjected to the action in the same session are stored in association with each other. The search history 61 and the action history 62 may be managed to be searchable by a database management system.

The query acquisition unit 51 acquires a main query from a user.

The additional query acquisition unit 52 acquires an additional query based on the main query. Here, the additional query acquisition unit 52 may acquire an additional query by executing the processing of the item extraction unit 56, the related item acquisition unit 57, and the addition acquisition unit 58 in real time based on the main query.

Instead of the real-time processing, a plurality of sets of an original query (corresponding to the main query) and an additional query associated with each other may be stored in advance in a database (not shown), and the additional query acquisition unit 52 may acquire the additional query associated with the main query from the database. In this case, the additional query acquisition unit 52 has, in advance, a function of acquiring each of a plurality of original queries stored in the search history 61 as an original query to be processed, and the processing of the item extraction unit 56, the related item acquisition unit 57, and the addition acquisition unit 58 is executed in advance for the original query to be processed. The original query to be processed may be each of a plurality of deduplicated queries.

The item extraction unit 56 extracts at least one item from a plurality of items stored in advance, based on each original query or the main query (hereinafter collectively referred to as a “first query”). The item extraction unit 56 may extract at least one item, which is stored in association with the first query, from the search history 61.

Here, the item extraction unit 56 extracts, from the search history 61, items selected based on the first query and subjected to a first action (for example, purchase), and when the number of the extracted items is smaller than a first required number, the item extraction unit 56 may further extract, from the search history 61, items selected based on the first query and subjected to a second action (for example, browsing).

The related item acquisition unit 57 acquires other items associated with each of extracted items. More specifically, the related item acquisition unit 57 may select other items stored in association with each of the at least one extracted item from the action history 62. The related item acquisition unit 57 selects other items subjected to the first action together with each of the at least one extracted item from the action history 62, and when the number of the selected other items is smaller than a second required number, the related item acquisition unit 57 may further select other items subjected to the second action together with each of the at least one extracted item from the action history 62.

The related item acquisition unit 57 may calculate a first score of the selected other item with respect to the selected item. The first score is a value obtained by dividing the number of times that the predetermined action has been performed on the selected item and the selected other item together by the product of the number of times that the predetermined action has been performed on the selected item and the number of times that the predetermined action has been performed on the selected other item.

The addition acquisition unit 58 acquires at least one query associated with another item as an additional query (second query). More specifically, the addition acquisition unit 58 may acquire a past query associated with selected other item from the search history 61 as the additional query.

The addition acquisition unit 58 may calculate a second score of a past search query with which the selected other item has been retrieved. The second score is a value obtained by dividing the number of times that search has been performed based on the past query and a predetermined action has been performed on the other item by the product of the number of times that the search has been performed based on the past query and the number of times that the predetermined action has been performed on the other item.

The item search unit 53 selects an item based on the main query. The item search unit 53 also selects an item based on the additional query.

The advertisement search unit 54 selects an advertisement item based on the main query. The advertisement search unit 54 also selects an advertisement item based on the additional query.

The display unit control 55 outputs information corresponding to the additional query together with the item retrieved for based on the main query. An output destination of the information may be the user terminal 2. The display control unit 55 may output information for displaying both an item selected based on the first query and an item selected based on the additional query. More specifically, the display control unit 55 may output information for displaying the item selected based on the first query in association with the first query and displaying the item selected based on the additional query in association with the additional query. Here, the display control unit 55 may output information for displaying some of the above and displaying the advertisement item selected based on the additional query. The display control unit 55 may output information for displaying the advertisement item selected based on the additional query in association with the additional query.

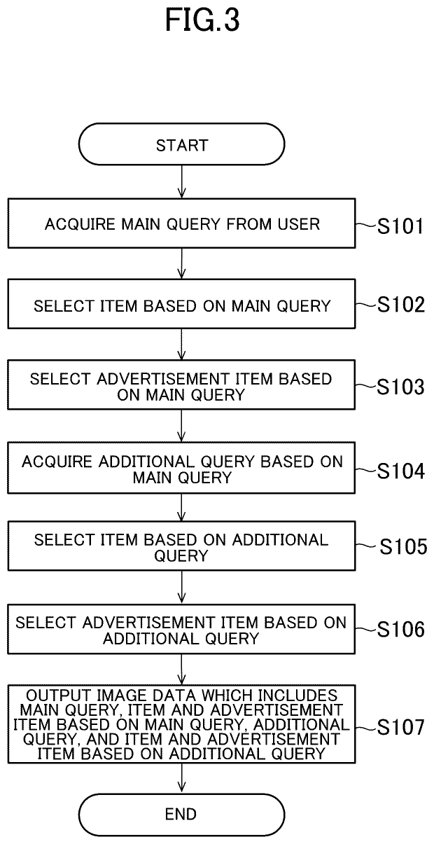

The processing of the search system will now be described in more detail. FIG. 3 is a flowchart schematically showing an example of the processing of the search system.

First, the query acquisition unit 51 acquires a main query from a user (S101). More specifically, the query acquisition unit 51 acquires a query inputted by the user from the user terminal 2 as the main query.

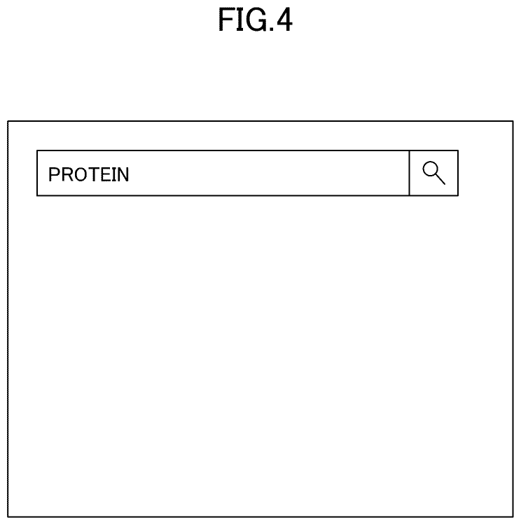

FIG. 4 is a diagram showing an example of a screen on which a query is inputted. In the example of FIG. 4, “protein” is inputted as the main query.

Here, the query acquisition unit 51 may correct variations in expression of the query inputted by the user, and acquire the corrected query as the main query. More specifically, the query acquisition unit 51 may delete unnecessary characters, standardize a notation of katakana, hiragana, and kanji, and standardize parts of speech for the inputted query.

When the main query is acquired, the item search unit 53 selects an item from an item database based on the main query (S102). The item database stores attribute information and description information of each item, and the item search unit 53 selects an item having attribute information or description information satisfying a condition indicated by the main query.

The advertisement search unit 54 selects an advertisement item to be displayed from a plurality of advertisement items registered in an advertisement database, based on the main query (S103). The advertisement database stores advertisement items in association with queries, and the advertisement search unit 54 selects an advertisement item associated with the main query. An advertisement item corresponding to a query (keyword) in the advertisement database may be determined or set by an advertiser who bids and wins the keyword.

The additional query acquisition unit 52 acquires an additional query based on the main query (S104). The processing of the additional query acquisition unit 52 will be described in detail later.

When the additional query is acquired, the item search unit 53 selects an item from the item database based on the additional query (S105). The advertisement search unit 54 selects an advertisement item to be displayed from a plurality of advertisement items registered in the advertisement database, based on the additional query (S106).

The display control unit 55 outputs control information (image data) for displaying a screen which includes the main query, the item and the advertisement item which are selected based on the main query, the additional query, and the item and the advertisement item which are selected based on the additional query (S107).

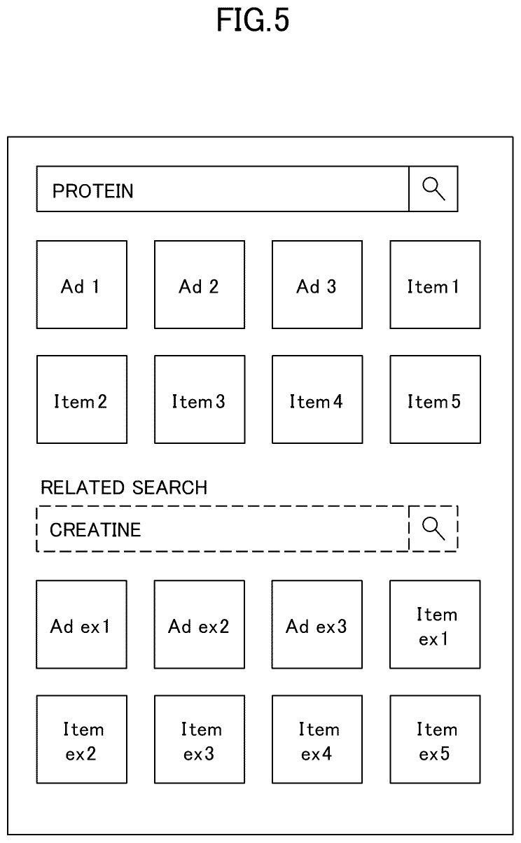

FIG. 5 is a diagram showing an example of a screen displayed based on an output of the display control unit 55. In the example of FIG. 5, the additional query acquisition unit 52 acquires “creatine” as the additional query with respect to “protein” corresponding to the main query. Further, the display control unit 55 arranges, for example immediately below the main query, advertisement items Ad1 to Ad3 acquired based on the main query and items Item1 to Item5 acquired based on the main query, thereby generating data for displaying these items in correspondence with each other. The display control unit 55 arranges, for example immediately below the additional query, advertisement items, Ad ex1 to Ad ex3, acquired based on the additional query and items, Item ex1 to Item ex5, acquired based on the additional query, thereby generating data for displaying these items in correspondence with each other. The display control unit 55 may display the additional query in a region having a shape similar to the search window so that the additional query can be recognized as a query.

In addition, the display control unit 55 may arrange only the additional query on the screen in a visible state, and generate data so that advertisement items acquired based on the additional query and items acquired based on the additional query are displayed when an icon arranged near the additional query is clicked.

Many users are not sure what they really want or are not even skilled in searching. Therefore, an inputted main query is not always optimal. By displaying items or advertisements based on another query, variation of an item increases, and for example, an item desired by a user can be found more quickly. In addition, the additional query is clearly indicated and the additional query and an acquired item are displayed in correspondence with each other, which makes it possible to avoid confusion of a user who views images of increased variety of items. Further, a user can easily find an item and user's confusion is reduced, and accordingly the user is less likely to give up the search for the item in the middle. Thus, it is possible to reduce a waste of user's time while efficiently operating the system.

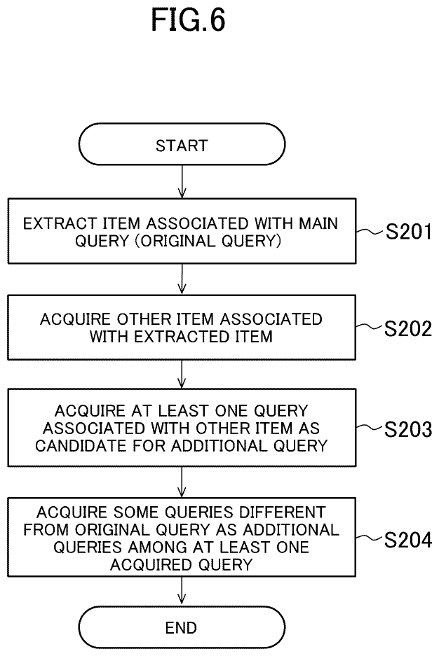

The processing of the additional query acquisition unit 52 will now be described in detail. FIG. 6 is a diagram showing an example of the processing of the additional query acquisition unit 52. In the processing shown in FIG. 6, the additional query acquisition unit 52 acquires an additional query using the search history 61 and the action history 62 after the main query is inputted.

The item extraction unit 56 included in the additional query acquisition unit 52 first extracts an item associated with the main query (hereinafter, also referred to as an “original query”) (S201). More specifically, the additional query acquisition unit 52 extracts an item stored in association with the original query, from the search history 61.

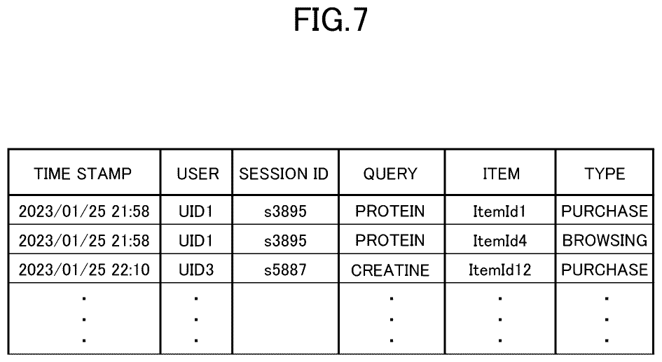

FIG. 7 is a diagram showing an example of data stored in the search history 61. The search history 61 stores information on at least one item in association with each of a plurality of past queries, the at least one item are selected based on corresponding one of the plurality of past queries and subjected to a predetermined action (for example, browsing or purchase). The search history 61 is data indicating mapping between a query and an item.

In the example of FIG. 7, the search history 61 stores time stamp, user, query, item, and type of action. Specifically, the time stamp is time when an action indicated in the type has been executed, the user is identification information of a user who has performed input of a query and the action, and the item is identification information of the item displayed based on the query and subjected to the action. When “purchase” is set in the type, a query which has triggered the purchase, a time stamp at the purchase, and identification information of the purchased item are set. When a search based on a query and an action have been performed in the same session, the query and the item subjected to the action may be associated with each other. In the search history 61, only items led to an action are associated with a query, thereby avoiding a use of an item, retrieved based on the query but improper, for the processing.

Here, the item extraction unit 56 first extracts, from the search history 61, items which are retrieved based on a query and subjected to an action of purchase, and when the number of the extracted items is smaller than a required extraction number (threshold value), the item extraction unit 56 may further extract items which are retrieved based on the query and subjected to an action of browsing. In other words, the item extraction unit 56 first extracts items for a first action (here, purchase) having high accuracy of relevance but a smaller amount, and when the number of the extracted items is equal to or less than a threshold value, the item extraction unit 56 further extracts items for a second action (here, browsing) having low accuracy of relevance but a larger amount. This makes it possible to balance the accuracy and the amount of additional queries that can be finally obtained.

The item extraction unit 56 may further generate a score Sc1 for each extracted item. When a query q and an item p are associated with each other, the score Sc1 for a combination of the query q and the item p may be calculated as shown in the following expression.

Sc1=SQP(q,p)/(SQ(q)×SP(p))

Here, SQP(q,p) is the number of times that a user has performed a search based on the query q and has performed one action (for example, purchase) on the item p, SQ(q) is the number of times that a user has performed the search based on the query q, and SP(p) is the number of times that a user has purchased the item p. Each of SQP(q,p), SQ(q), and SP(p) is equivalent to the sum of the number of times counted for each of one or more users (for example, all active users using the search system) who are targets of score calculation.

The number of sessions in which a search or action has been performed may be used as the number of times that the search or action has been performed. A score is calculated for an action used for extracting an item. For example, when an item purchased after a query is extracted, a score for a combination of the query and the item is calculated for the action of purchase.

When an item is extracted in the processing of S201, the related item acquisition unit 57 included in the additional query acquisition unit 52 acquires another item associated with the extracted item (S202). More specifically, the related item acquisition unit 57 selects another item which is stored in association with each of the at least one extracted item, from the action history 62.

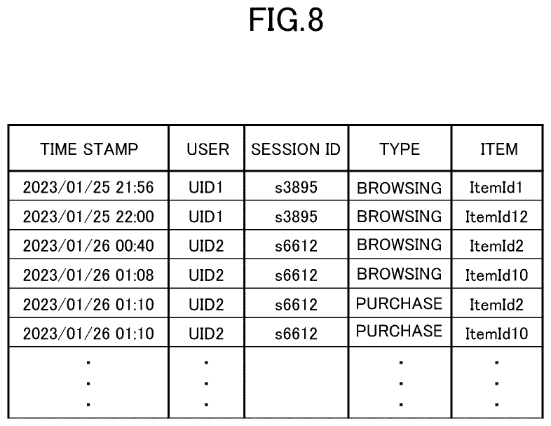

FIG. 8 is a diagram showing an example of data stored in the action history 62. The action history 62 stores a plurality of items subjected to a predetermined action together, in association with each other. The action history 62 is data indicating mapping of a plurality of items. In the example of FIG. 8, the items are associated with each other by a session ID and a type. More specifically, items indicated by item IDs described in a plurality of columns having the same session IDs and types are associated with each other as a plurality of items subjected to the predetermined action together.

In the example of FIG. 8, the action history 62 stores time stamp, user, type, and a plurality of items in mutually associated manner. Specifically, in the action history 62, the time stamp is time when an action indicated in the type has been executed, the user is identification information of a user who has performed the action, and identification information of an item subjected to the action indicated in the type is stored in each item. When the type is “purchase”, a time stamp at the purchase and identification information of an item purchased in the same cart are set. When the type is “browsing”, for example, the time stamp indicates browsing time, and identification information of a certain item and an item browsed before or after the certain item is set in a column of the item.

Here, the related item acquisition unit 57 selects, from the action history 62, other item subjected to the action of purchase together with each of the at least one extracted item, and when the number of the selected other items is smaller than a required selection number (threshold value), the related item acquisition unit 57 may further select other items subjected to the action of browsing together with each of the at least one extracted item from the action history 62. In other words, the related item acquisition unit 57 first selects other items for the first action (here, purchase) having high accuracy of relevance but a smaller amount, and when the number of the selected items is equal to or less than the threshold value, the related item acquisition unit 57 further selects items for the second action (here, browsing) having low accuracy of relevance but a larger amount. This makes it possible to balance the accuracy and the amount of additional queries that can be finally obtained.

The related item acquisition unit 57 may further generate a score Sc2 for each of combinations of items and other items. When a certain item x and another item y are combined, the score Sc2 for the combination of the item x and the item y may be calculated as shown in the following expression, where SXY(x,y) is the number of times that the user has performed one action (for example, purchase) on the item x and the item y together, SX(x) is the number of times that the user has performed one action on the item x, and SY(y) is the number of times that the user has performed the action on the item y.

$$Sc 2 = SXY ( x , y ) / ( SX ( x ) \times SY ( y ) )$$

A score is calculated for an action used for selecting another item. For example, when another item purchased together with a certain item is selected, a score for a combination of these items is calculated for the action of purchase. As in the calculation of the score Sc1, each of SXY(x,y), SX(x), and SY(y) is equivalent to the sum of the number of times counted for each of one or more users who are targets of the score calculation.

When another item is acquired in the processing of S202, the addition acquisition unit 58 included in the additional query acquisition unit 52 acquires at least one query associated with the other item as a candidate for an additional query (S203). More specifically, the addition acquisition unit 58 acquires a past query associated with other item as a candidate for the additional query, from the search history 61 (S203).

Here, the addition acquisition unit 58 acquires queries for retrieving other item subjected to an action of purchase from the search history 61, and when the number of acquired queries is smaller than a required acquisition number (threshold value), the addition acquisition unit 58 may further extract queries for retrieving other item subjected to an action of browsing. This makes it possible to balance the accuracy and the amount of additional queries that can be finally obtained.

The addition acquisition unit 58 may further generate a score Sc3 for each of combinations of other items and queries. The method of calculating the score Sc3 is the same as that of the score Sc1. When a query q is associated with another item p, the score Sc3 for the combination of the query q and the item p may be calculated as shown in the following expression, where SQP(q,p) is the number of times that the user has performed a search based on the query q and has performed one action (for example, purchase) on the item p, SQ(q) is the number of times that the user has performed a search based on the query q, and SP(p) is the number of times that the user has purchased the item p.

$$Sc 3 = SQP ( q , p ) / ( SQ ( q ) \times SP ( p ) )$$

The score Sc3 is calculated for an action used for acquisition of a query. For example, when a query used for a search for the purchased other item p is acquired, the score Sc3 for the combination of the query and the item is calculated for the action of purchase. As in the calculation of the score Sc1, each of SQP(q,p), SQ(q), and SP(p) is equivalent to the sum of the number of times counted for each of one or more users who are the targets of the score calculation.

When the candidate for the additional query is acquired, the addition acquisition unit 58 acquires some queries, which are different from the original query, as additional queries among the at least one acquired query (S204). The addition acquisition unit 58 may acquire an additional query based on a score from queries which are different from the original query among the at least one acquired query. The addition acquisition unit 58 may acquire some queries, which are different from the original query, as additional queries among the at least one acquired query, based on at least part of the scores Sc1 to Sc3.

All of the scores Sc1 to Sc3 may be used to acquire an additional query, or part of the scores, for example, the scores Sc1 and Sc3, and the scores Sc1 and Sc2, may be used. When a plurality of scores are used, the addition acquisition unit 58 may acquire a product of the scores and acquire a query having the largest product as the additional query, or may acquire a query having the largest value obtained by weighting and adding the scores as the additional query. Instead of calculating a value from a plurality of scores, the addition acquisition unit 58 may sort queries by one score, sort the queries by a next score when there are a plurality of queries indicating the same score, and acquire a query at the highest level as the additional query as a result of the sorting.

By the processing from S201 to S204, the additional query is acquired from the original query.

In the present embodiment, an item itself related to an item selected by the original query is not found as a related item, but the additional query for finding a related item is searched for. This makes it possible to find a related item in units of queries, and even when there is a small amount of data on a relationship between items, such as a new item, for example, it is possible to display the new item as the related item. Thus, more various and useful items can be displayed. Further, the user can easily infer a relationship by comparing the main query and the additional query, and can reduce a burden during a search for a displayed item. Furthermore, an advertisement is also displayed for the related query, and accordingly an opportunity for an item to be advertised can be increased, which is beneficial to an advertiser as well.

Here, the main query and the additional query may be stored in advance in the database in association with each other. In this case, the additional query acquisition unit 52 acquires the additional query associated with the main query from the database, in the processing of S104 in FIG. 3.

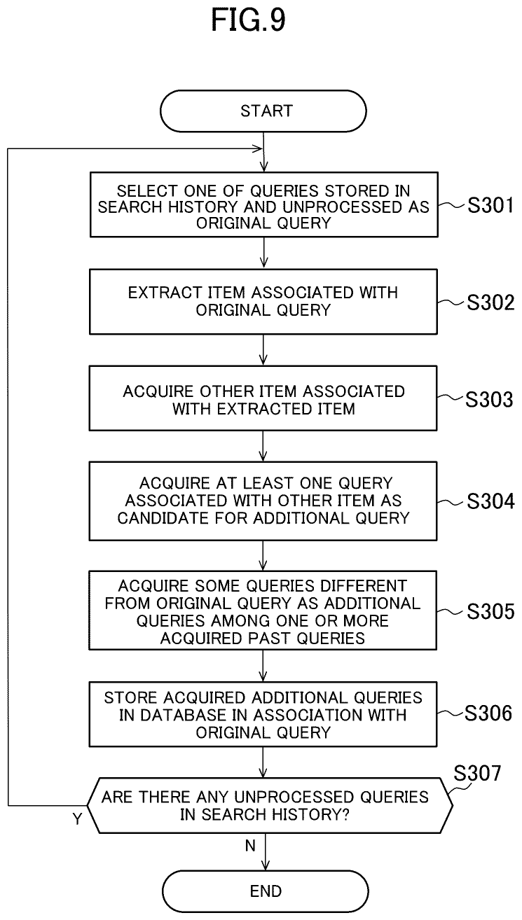

FIG. 9 is a diagram showing another example of processing of the additional query acquisition unit 52. FIG. 9 shows the processing for storing the original query and the additional query in advance in the database in association with each other.

The additional query acquisition unit 52 first selects one of queries stored in the search history 61 and unprocessed, as the original query (S301). The original query corresponds to the main query in the processing in FIG. 6.

Here, the additional query acquisition unit 52 may correct the variations in expression of the selected query, and may acquire the corrected query as the original query. More specifically, the additional query acquisition unit 52 may delete unnecessary characters, standardize the notation of katakana, hiragana, and kanji, and standardize parts of speech for the selected query.

Then, the item extraction unit 56 extracts the item associated with the original query (S302). This processing is similar to the processing of S201 in FIG. 6 and therefore, a detailed description will be omitted. The item extraction unit 56 first extracts the items for the first action (here, purchase) having high accuracy of relevance but a smaller amount, and when the number of the extracted items is equal to or less than the threshold value, the item extraction unit 56 may further extract the items for the second action (here, browsing) having low accuracy of relevance but a larger amount. The item extraction unit 56 may generate the score Sc1 for each extracted item.

When the item is extracted based on the original query, the related item acquisition unit 57 acquires another item associated with the extracted item (S303). This processing is similar to the processing of S202 in FIG. 6 and therefore, the detailed description will be omitted. The related item acquisition unit 57 first selects other items for the first action (here, purchase) having high accuracy of relevance but a smaller amount, and when the number of the selected items is equal to or less than the threshold value, the related item acquisition unit 57 may further select the items for the second action (here, browsing) having low accuracy of relevance but a larger amount. The related item acquisition unit 57 may further generate the score Sc2 for each of the combinations of the items and the other items.

When the other item is acquired, the addition acquisition unit 58 included in the additional query acquisition unit 52 acquires at least one query associated with the other item as the candidate for the additional query (S304). This processing is similar to the processing of S203 in FIG. 6 and therefore, the detailed description will be omitted. The addition acquisition unit 58 acquires the queries for retrieving other items subjected to the action of purchase from the search history 61, and when the number of acquired queries is smaller than the required acquisition number (threshold value), the addition acquisition unit 58 may further extract the queries for retrieving other items subjected to the action of browsing. Further, the addition acquisition unit 58 may generate the score Sc3 for each of the combinations of the other items and the queries.

When the candidate for the additional query is acquired, the addition acquisition unit 58 acquires some queries, which are different from the original query, as the additional queries among the at least one acquired query (S305). This processing is similar to the processing of S204 in FIG. 6 and therefore, the detailed description will be omitted.

When the additional queries are acquired, the additional query acquisition unit 52 stores, in the database, the acquired additional queries in association with the original query (S306). When there are unprocessed queries in the search history 61 (Y in S307), the additional query acquisition unit 52 repeats the processing on and after S301. On the other hand, when there is no unprocessed query in the search history 61 (N in S307), the processing in FIG. 9 is ended.

Even when the original query is acquired in advance from the search history 61 and the additional queries corresponding to the original query are obtained, similar advantageous effects can be obtained. The scope of the present invention is not limited to the above-described embodiment. For example, the selection of the item and the advertisement item in S102 and S103 in FIG. 3 may be performed after the acquisition of the additional query, and the order of other processing may also be changed as long as the dependencies are not broken.

While there have been described what are at present considered to be certain embodiments of the invention, it will be understood that various modifications may be made thereto, and it is intended that the appended claims cover all such modifications as fall within the true spirit and scope of the invention.

### [Addendum]

This specification discloses various technical ideas, including the following disclosures.

(1) An information processing system including: a first acquisition means which acquires a first query; an item extraction means which extracts at least one item from a plurality of items stored in advance, based on the first query; a relation acquisition means which acquires another item associated with the at least one item being extracted; a second acquisition means which acquires at least one query associated with the other item as a second query; and an output means which outputs information according to the second query together with an item retrieved based on the first query.

(2) The information processing system according to (1), in which at least one item is stored in a search history in association with each of a plurality of past queries, the at least one item being selected based on a corresponding one of the plurality of past queries, and subjected to a predetermined action; a plurality of items subjected to the predetermined action together are stored in an action history in association with each other; the item extraction means extracts at least one item which is stored in association with the first query, from the search history; the relation acquisition means selects, from the action history, the other item which is stored in association with each of the at least one item being extracted; and the second acquisition means acquires a past query associated with the other item being selected, as the second query, from the search history.

(3) The information processing system according to (2), in which the search history stores information on at least one item in association with each of a plurality of past queries, the at least one item being selected based on a corresponding one of a plurality of past queries, and subjected to a first action or a second action, and the action history stores a plurality of items subjected to the first action or the second action together in association with each other; the item extraction means extracts, from the search history, items selected based on the first query and subjected to the first action, and when the number of the items being extracted is smaller than a first required number, the item extraction means further extracts, from the search history, items selected based on the first query and subjected to the second action; and the relation acquisition means selects, from the action history, other items subjected to the first action together with each of the at least one item being extracted, and when the number of the other items being selected is smaller than a second required number, the relation acquisition means further selects, from the action history, other items subjected to the second action together with each of the at least one item being extracted.

(4) The information processing system according to (2) or (3), in which the second acquisition means acquires, as a second query, part of past queries associated with the selected other item based on at least part of a first score of an item extracted based on the first query, a second score of the other item being selected with respect to the item being selected, and a third score of a past search query with which the selected has been retrieved.

(5) The information processing system according to (4), in which the first score is a value obtained by dividing the number of times that the predetermined action has been performed on the item being extracted based on the first query by a product of the number of times that the item has been extracted based on the first query and the number of times that the predetermined action has been performed on the item.

(6) The information processing system according to (4) or (5), in which the second score is a value obtained by dividing the number of times that the predetermined action has been performed on a selected item and selected other item together by a product of the number of times that the predetermined action has been performed on the selected item and the number of times that the predetermined action has been performed on the selected other item.

(7) The information processing system according to any one of (4) to (6), in which the third score is a value obtained by dividing the number of times that a search has been performed based on a past query and the predetermined action has been performed on the other item by a product of the number of times that a search has been performed based on the past query and the number of times that the predetermined action has been performed on the other item.

(8) The information processing system according to any one of (1) to (7), in which the output means displays both an item selected based on the first query and an item selected based on the second query.

(9) The information processing system according to (8), in which the output means displays an item selected based on the first query in correspondence with the first query, and displays an item selected based on the second query in correspondence with the second query.

(10) The information processing system according to any one of (1) to (9), in which the output means displays an advertisement item selected based on the second query.

(11) The information processing system according to (10), in which the output means displays an advertisement item selected based on the second query, in correspondence with the second query.

(12) The information processing system according to any one of (1) to (11), in which the first acquisition means acquires a first query from a user.

(13) The information processing system according to any one of (1) to (11), in which the first acquisition means acquires each of the queries executed in the past as a first query; the second acquisition means stores at least one query associated with the other item being acquired, as a second query, in a database in association with the first query; the information processing system further includes a corresponding query acquisition means that acquires the second query from the database based on an input query acquired from a user; and the output means outputs information corresponding to the second query together with an item retrieved based on the input query.

(14) An information processing method including: acquiring a first query; extracting at least one item from a plurality of items stored in advance, based on the first query; acquiring another item associated with the at least one item being extracted; acquiring at least one query associated with the other item as a second query; and outputting information according to the second query together with an item retrieved based on the first query.

(15) A program for causing a computer to function as: a first acquisition means which acquires a first query; an item extraction means which extracts at least one item from a plurality of items stored in advance, based on the first query; a relation acquisition means which acquires another item associated with the at least one item being extracted; a second acquisition means which acquires at least one query associated with the other item as a second query; and an output means which outputs information according to the second query together with an item retrieved based on the first query.

What is claimed is:

1. An information processing system comprising:
at least one processor; and
at least one memory device that stores a plurality of instructions which, when executed by the at least one processor, causes the at least one processor to:
acquire a first query;
extract at least one item from a plurality of items stored in advance, based on the first query;
acquire another item associated with the at least one item being extracted;
acquire at least one query associated with the other item as a second query; and
output information according to the second query together with an item retrieved based on the first query.

2. The information processing system according to claim 1, wherein
at least one item is stored in a search history in association with each of a plurality of past queries, the at least one item being selected based on a corresponding one of the plurality of past queries, and subjected to a predetermined action,
a plurality of items subjected to the predetermined action together are stored in an action history in association with each other,
at least one item which is stored in association with the first query, is extracted from the search history,
the other item, which is stored in association with each of the at least one item being extracted, is selected from the action history, and
a past query associated with the other item being selected is acquired, as the second query, from the search history.

3. The information processing system according to claim 2, wherein
the search history stores information on at least one item in association with each of a plurality of past queries, the at least one item is selected based on a corresponding one of a plurality of past queries, and subjected to a first action or a second action, and the action history stores a plurality of items subjected to the first action or the second action together in association with each other,
items selected based on the first query and subjected to the first action are extracted from the search history, and when the number of the items being extracted is smaller than a first required number, items selected based on the first query and subjected to the second action are extracted from the search history, and
other items subjected to the first action together with each of the at least one extracted item are selected from the action history, and when the number of the other items being selected is smaller than a second required number, other items subjected to the second action together with each of the at least one extracted item are selected from the action history.

4. The information processing system according to claim 2, wherein
part of past queries associated with the selected other item are acquired as a second query based on at least part of a first score of an item extracted based on the first query, a second score of the other item being selected with respect to the item being selected, and a third score of a past search query with which the selected other item has been retrieved.

5. The information processing system according to claim 4, wherein
the first score is a value obtained by dividing the number of times that the predetermined action has been performed on the item being extracted based on the first query by a product of the number of times that the item has been extracted based on the first query and the number of times that the predetermined action has been performed on the item.

6. The information processing system according to claim 4, wherein
the second score is a value obtained by dividing the number of times that the predetermined action has been performed on a selected item and selected other item together by a product of the number of times that the predetermined action has been performed on the selected item and the number of times that the predetermined action has been performed on the selected other item.

7. The information processing system according to claim 4, wherein
the third score is a value obtained by dividing the number of times that a search has been performed based on a past query and the predetermined action has been performed on the other item by a product of the number of times that a search has been performed based on the past query and the number of times that the predetermined action has been performed on the other item.

8. The information processing system according to claim 1, wherein the plurality of instructions cause the at least one processor to display, in the outputting, both an item selected based on the first query and an item selected based on the second query.

9. The information processing system according to claim 8, wherein
an item selected based on the first query is displayed in correspondence with the first query, and an item selected based on the second query is displayed in correspondence with the second query.

10. The information processing system according to claim 1, wherein the plurality of instructions cause the at least one processor to display, in the outputting, an advertisement item selected based on the second query.

11. The information processing system according to claim 10, wherein
an advertisement item selected based on the second query is displayed in correspondence with the second query.

12. The information processing system according to claim 1, wherein
the first query is acquired from a user.

13. The information processing system according to claim 1, wherein
each of the queries executed in the past is acquired as a first query,
at least one query associated with the acquired other item is stored as a second query, in a database in association with the first query,
the plurality of instructions cause the at least one processor to acquire the second query from the database based on an input query acquired from a user, and
information corresponding to the second query is output together with an item retrieved based on the input query.

14. An information processing method comprising:
acquiring, with at least one processor operating with a memory device in a system, a first query;
extracting, with the at least one processor operating with the memory device in the system, at least one item from a plurality of items stored in advance, based on the first query;
acquiring, with the at least one processor operating with the memory device in the system, another item associated with the at least one item being extracted;
acquiring, with the at least one processor operating with the memory device in the system, at least one query associated with the other item as a second query; and
outputting, with the at least one processor operating with the memory device in the system, information according to the second query together with an item retrieved based on the first query.

15. A non-transitory computer readable storage medium storing a plurality of instructions, wherein when executed by at least one processor, the plurality of instructions cause the at least one processor to:
acquire a first query;
extract at least one item from a plurality of items stored in advance, based on the first query;
acquire another item associated with the at least one item being extracted;
acquire at least one query associated with the other item as a second query; and
output information according to the second query together with an item retrieved based on the first query.
